(19) United States
(12) Patent Application Publication
(10) Pub. No.: US 2020/0226824 A1
(43) Pub. Date: Jul. 16, 2020

(54) SYSTEMS AND METHODS FOR 3D SCANNING OF OBJECTS BY PROVIDING REAL-TIME VISUAL FEEDBACK

(71) Applicant: Guangdong Kang Yun Technologies Limited, Guangzhou City (CN)

(72) Inventor: Seng Fook Lee, Guangzhou City (CN)

(21) Appl. No.: 16/616,180

(22) PCT Filed: Jun. 15, 2018
(86) PCT No.: PCT/CN2018/091576

§ 371 Date: Nov. 22, 2019

Related U.S. Application Data
(60) Provisional application No. 62/584,134, filed on Nov. 10, 2017.

(51) Int. Cl. G06T 17/00; G01B 11/02; G01B 11/24; G01S 17/894; H04N 13/261; H04N 13/239

(52) U.S. Cl. CPC G06T 17/00; G01B 11/022; G01B 11/24; G06T 2215/16; H04N 13/261; H04N 13/239; G06T 2200/08; G01S 17/894

(57) ABSTRACT

A method for three-dimensional (3D) scanning of an object is provided. The method includes taking at least one image shot of the object for scanning; creating a point cloud of the object; providing a feedback on a display screen in real-time so that a user can review at least one of a rendering and scanning of the object in real-time; and rendering the object in real-time by merging and processing the point cloud with at least one image shot for generating a 3D scanned image. When the user wants to make any changes in the rendering of the object then the user provides an input during the rendering and processing of the object for enhancing a quality of the scanned image in real-time. The feedback may be sent to the feedback module in real-time for presenting to the user.

### CROSS REFERENCE TO RELATED APPLICATIONS

This application is a national stage application under 35 U.S.C. 371 of PCT Application No. PCT/CN2018/091576, filed 15 Jun. 2018, which PCT application claimed the benefit of U.S. Provisional Patent Application No. 62/584,134, filed 10 Nov. 2017, the entire disclosure of each of which are hereby incorporated herein by reference.

### TECHNICAL FIELD

The presently disclosed embodiments relate to the field of imaging and scanning technologies. More specifically, embodiments of the present disclosure relate to systems and methods for providing a visual feedback to a user showing rendering and 3D scanning of an object in real-time so that the user can monitor or review a quality of the scanning/rendering in the real-time.

### BACKGROUND

A three-dimensional (3D) scanner may be a device capable of analysing environment or a real-world object for collecting data about its shape and appearance, for example, colour, height, length width, and so forth. The collected data may be used to construct digital three-dimensional models. Usually, 3D laser scanners create “point clouds” of data from a surface of an object. Further, in the 3D laser scanning, physical object's exact size and shape is captured and stored as a digital 3-dimensional representation. The digital 3-dimensional representation may be used for further computation. The 3D laser scanners work by measuring a horizontal angle by sending a laser beam all over the field of view. Whenever the laser beam hits a reflective surface, it is reflected back into the direction of the 3D laser scanner.

In the present 3D scanners or systems, there exist multiple limitations. For example, a higher number of pictures need to be taken by a user for making a 360-degree view. Also the 3D scanners take more time for taking or capturing pictures. Further, a stitching time is more for combining the more number of pictures (or images). Similarly, the processing time for processing the more number of pictures increases. Further, because of more number of pictures, the final scanned picture becomes heavier in size and may require more storage space. In addition, the user may have to take shots manually that may increase the user's effort for scanning of the objects and environment. Further, the present 3D scanner does not provide real-time merging of point clouds and image shots. Also a final product is presented to the user, there is no way to show intermediate process of rendering to the user. Further, in existing systems, some processor in a lab does the rendering of the object.

### SUMMARY

In light of above discussion, there exists need for better techniques for three-dimensional (3D) scanning and rendering of objects in real-time. The present disclosure provides 3D scanning systems and methods for 3D scanning of objects by providing visual feedbacks about scanning and rendering of object in real-time to a user. The user can check and make changes, if required, for enhancing a scanned image.

An objective of the present disclosure is to provide systems and methods for providing visual feedback to the user for monitoring/reviewing or checking a quality of scanning/object rendering in real-time.

An objective of the present disclosure is to provide systems and methods for providing a visual feedback to a user by showing rendering and 3D scanning of an object in real-time so that to enable the user to monitor or check a quality of scanning in real-time

Another objective of the present disclosure is to provide a systems and methods for real-time rendering of objects based on a visual feedback provided to a user in real-time.

Another objective of the present disclosure is to provide a systems and methods for three-dimensional scanning and rendering of objects in real-time based on a visual feedback provided to a user in real-time.

A yet another objective of the present disclosure is to provide systems and methods for enabling a user to check a quality of scanning by rendering a camera image with point clouds and based on visual feedbacks provided to the user in real-time.

Another objective of the present disclosure is to provide a real-time visual feedback module for 3D scanning system for scanning of a plurality of an object. The visual feedback module enables a user to check an extent and quality of scanning in real-time while an image shot is being rendered with a point cloud of the object.

Another objective of the present disclosure is to provide a system and method for providing visual feedbacks to a user in real-time while 3D rendering of a point cloud with an image shot for generating a scanned image of an object.

Another objective of the present disclosure is to provide scanning system having a visual feedback module and a depth sensor comprising an RGBD camera for scanning. Further, the scanning system provides a visual feedback about the 3D scanning to a user in real-time to enable the user to monitor an extent and quality of scanning. The depth sensor or the RGBD camera may be configured to create a depth map or point cloud of an object. The depth map may be an image or image channel that contains information relating to the distance of the surfaces of scene objects from a viewpoint. The point cloud may be a set of data points in some coordinate system. Usually, in a three-dimensional coordinate system, these points may be defined by X, Y, and Z coordinates, and may intend to represent an external surface of the object.

A yet another objective of the present disclosure is to provide a 3D object scanning system having a depth sensor or an RGBD camera/sensor for creating a point cloud of the object. The point cloud may be merged and processed with a scanned image for creating a real-time rendering of the object. In some embodiments, the depth sensor may be at least one of a RGB-D camera, a Time-of-Flight (ToF) camera, a ranging camera, and a Flash LIDAR.

Another objective of the present disclosure is to provide a 3D scanning system configured to send real-time feedback including a visual feedback to a visual display module or a screen, so that a user can review the scanning of the object in real-time. This way, the user can monitor or check the extent or quality of the scanning of the object while rendering is actually happening.

Another objective of the present disclosure is to provide a 3D scanning system including a RGBD camera/sensor or a depth sensor for creating a point cloud of an object and a feedback module for providing a visual feedback to a user. During a rendering process of the point cloud of the object, the user may be presented with the visual feedback about scanning process. Then, the user may check or may make some modification during the rendering process for enhancing the quality of the scanning of the object. Therefore, an effort and time for processing the point cloud and image shots for generating good quality scanned image may be reduced.

The present disclosure also provides 3D scanning systems and methods for generating a good quality 3D model including scanned images of object(s) with a less number of images or shots for completing a 360-degree view of the object.

The present disclosure provides feedback-based laser-guided coordinate systems and methods for advising an exact position to the user for taking one or more shots comprising one or more photos of an object one by one by providing an audio feedback or a video feedback about the exact position.

The present disclosure also provides feedback-based systems and methods for generating three-dimensional (3D) scanned image of an object comprising a symmetrical and an unsymmetrical object or of an environment.

The present disclosure also provides feedback-based systems and methods for generating a 3D model including scanned images of object(s) by allowing the user to click a less number of images or shots for completing a 360-degree view of the object.

The present disclosure also provides feedback based scanning systems and methods for generating a 3D model including scanned images of object(s) in real-time.

An embodiment of the present disclosure provides a three dimensional (3D) scanning system for scanning of an object. The 3D scanning system includes one or more cameras configured to take at least one image shot of the object for scanning. The 3D scanning system also includes a depth sensor configured to create a point cloud of the object. The 3D scanning system further includes a feedback module configured to provide a feedback on a display screen in real-time so that a user can review at least one of a rendering and scanning of the object in real-time. The 3D scanning system also includes a processor configured to render the object in real-time by merging and processing the point cloud with the at least one image shot for generating a 3D scanned image. The user may provide an input during the rendering and processing of the object for enhancing a quality of the scanned image in real-time. The processor may send the feedback to the feedback module in real-time for presenting to the user.

Another embodiment of the present disclosure provides a laser guided 3D scanning system for a three dimensional (3D) scanning of an object. The laser guided 3D scanning system includes a scanner comprising a depth sensor configured to create a point cloud of the object; and one or more cameras configured to take at least one shot of the object for scanning. The laser guided 3D scanning system also includes a feedback module configured to provide a visual feedback on a display module in real-time so that a user can review at least one of a rendering and scanning of the object in real-time. The laser guided 3D scanning system also includes a processor based in a cloud network configured to receive the point cloud and the at least one image shot from the scanner; send the visual feedback to the feedback module in real-time for presenting to the user; render the object in real-time by merging and processing the point cloud with the at least one image shot to generate a 3D scanned image, wherein the user provides an input during the rendering and processing of the object for enhancing a quality of the 3D scanned image in real-time; and send the 3D scanned image of the object to the scanner for display to the user.

Another embodiment of the present disclosure provides a method for three-dimensional (3D) scanning of an object. The method includes taking at least one image shot of the object for scanning; creating a point cloud of the object; providing a feedback on a display screen in real-time so that a user can review at least one of a rendering and scanning of the object in real-time; and rendering the object in real-time by merging and processing the point cloud with at least one image shot for generating a 3D scanned image. When the user wants to make any changes in the rendering of the object then the user provides an input during the rendering and processing of the object for enhancing a quality of the scanned image in real-time. The feedback may be sent to the feedback module in real-time for presenting to the user.

In some embodiments, the method may also include defining an exact position co-ordinate for taking the at least one image shot.

Another embodiment of the present disclosure provides a method for laser guided three-dimensional scanning of an object. The method includes creating, by a depth sensor of a scanner, a point cloud of the object. The method also includes taking, by one or more cameras of the scanner, at least one image shot of the object for scanning. The method further includes providing, by a feedback module, a visual feedback on a display module in real-time so that a user can review at least one of a rendering and scanning of the object in real-time. The method also includes receiving, by a processor, a point cloud and the at least one image shot from the scanner; sending, by the processor, the visual feedback to the feedback module in real-time for presenting to the user; rendering, by the processor, the object in real-time by merging and processing the point cloud with the at least one image shot to generate a 3D scanned image, wherein the user provides an input during the rendering and processing of the object for enhancing a quality of the 3D scanned image in real-time; and sending, by the processor, the 3D scanned image of the object to the scanner for display to the user.

According to an aspect of the present disclosure, when the user wants to make any changes in the rendering of the object then the user provides an input during the rendering and processing of the object for enhancing a quality of the scanned image in real-time, wherein the feedback is sent to the feedback module in real-time for presenting to the user.

According to an aspect of the present disclosure, the depth sensor comprises at least one of a RGB-D camera, a Time-of-Flight (ToF) camera, a ranging camera, and a Flash LIDAR.

According to another aspect of the present disclosure, the input provided by the user comprises one or more attributes of rendering the object.

According to another aspect of the present disclosure, the one or more cameras takes the at least one shot of the object one by one based on the laser center co-ordinate and a relative width of a first shot.

According to another aspect of the present disclosure, the 3D scanning system includes a laser light is configured to indicate the exact position by using a green color for taking the at least one shot.

In some embodiments, the method may further include indicating the exact position by using a green color for taking each of the one or more shots separately, wherein a position for taking each of the one or more shots being different.

According to an aspect of the present disclosure, the processor is configured to process the shots or images in real-time and hence in less time the 3D model is generated.

Another embodiment of the present disclosure provides an automatic method for three-dimensional (3D) scanning of an object. The method includes capturing, defining a laser center co-ordinate for the object from a first shot of the object, wherein the object comprises at least one of a symmetrical object and an unsymmetrical object; defining an exact position for taking every shot of one or more shots after the first shot, wherein the exact position for taking the one or more shots is defined such that the laser center co-ordinate for the object remains undisturbed; indicating the exact position by using a green color for taking each of the one or more shots separately, wherein a position for taking each of the one or more shots being different; moving to the exact position for taking the one or more shots based on the indication; capturing the first shot and the one or more shots one by one based on the indication; and stitching and processing the first shot and the one or more shots to generate at least one three dimensional model comprising a scanned image of the object.

According to an aspect of the present disclosure, a laser-guided 3D scanning system takes a first shot (i.e. N1) of an object and based on that, a laser center co-ordinate may be defined for the object.

According to an aspect of the present disclosure, the laser center coordinate is kept un-disturbed while taking the plurality of shots of the object.

According to an aspect of the present disclosure, the feedback may include at least one of an audio feedback comprising an audio message and a video feedback comprising a video message.

According to an aspect of the present disclosure, for the second shot, the laser-guided 3D scanning system may provide a feedback about an exact position for taking the second shot (i.e. N2) and so on (i.e. N3, N4, and so forth). The robotic laser guided scanning system may self move to the exact position and take the second shot and so on (i.e. the N2, N3, N4, and so on).

In some embodiments, the feedback module comprises a visual feedback module configured to provide feedback as a visual feedback including a video message.

According to another aspect of the present disclosure, the laser center co-ordinate is kept un-disturbed while taking the plurality of shots of the object.

In some embodiments, the processing of point clouds and image shots may happen on a device in a cloud network.

In some embodiments, the laser light points a green light on an exact position for taking a next shot. Similarly, the laser light points a green light for signaling a position from where the next shot of the object for completing a 360-degree view of the object can be taken.

According to an aspect of the preset disclosure, the processor may define a laser center co-ordinate for the object from a first shot of the plurality of shots, wherein the processor defines the exact position for taking the subsequent shot without disturbing the laser center co-ordinate for the object based on a feedback.

According to another aspect of the present disclosure, the one or more cameras takes the plurality of shots of the object one by one based on a laser center co-ordinate and a relative width of the first shot.

According to another aspect of the present disclosure, the plurality of shots is taken one by one with a time interval between two subsequent shots.

The present disclosure provides a method and a system for 3D scanning of at least one of a symmetrical object and an unsymmetrical object. The unsymmetrical object comprises at least one uneven surface.

According to an aspect of the present disclosure, the processor may be configured to stitch and process the shots in real-time to generate at least one 3D scanned image.

According to another aspect of the present disclosure, the one or more cameras takes the plurality of shots of the object one by one based on a laser center co-ordinate and a relative width of a first shot of the object.

According to a further aspect of the present disclosure, due to discrete scanning steps, a less amount of shots may be needed for taking the complete 360-degree scanning of an object or an environment.

According to another aspect of the present disclosure, the one or more cameras may take the one or more shots of the object one by one.

According to a further aspect of the present disclosure, the 3D scanning system keeps the laser center co-ordinate undisturbed while taking the multiple shots. Further, the shots may be taken based on the laser center co-ordinate. Further, a relative width of the first shot (i.e. N1) may also help in defining a new co-ordinate of the 3D scanning system for taking multiple shots of the object. Hence, without disturbing the laser center the 3D scanning system can capture the overall or complete photo of the object. Therefore, there won't be any missing part of the object which scanning, which in turn may increase a quality of the scanned image. In some embodiments a visual feedback may be provided. Further, the user is provided with a real-time visual feedback on a display screen/module. Therefore, the user can see the scanning/rendering process in real-time, and if the user doesn't like the quality of scanning process, then the user may take measures like changing one or more rendering attributes or re-scanning the object.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 illustrates an exemplary environment where various embodiments of the present disclosure may function;

FIGS. 2A-2B illustrates different views of an exemplary three-dimensional (3D) scanning system comprising a depth sensor, in accordance with an embodiment of the present disclosure;

FIG. 3 is a block diagram illustrating system elements of an exemplary 3D scanning system, in accordance with various embodiments of the present disclosure; and

FIGS. 4A-4B illustrate a flowchart of a method for three-dimensional (3D) scanning of an object based on a visual feedback, in accordance with an embodiment of the present disclosure; and

FIGS. 5A-5C illustrate a flowchart of a method for three-dimensional (3D) scanning of an object based on a visual feedback based, in accordance with another embodiment of the present disclosure.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). To facilitate understanding, like reference numerals have been used, where possible, to designate like elements common to the figures.

### DETAILED DESCRIPTION

The presently disclosed subject matter is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

Reference throughout this specification to “a select embodiment”, “one embodiment” or “an embodiment” means that a particular feature, structure, or characteristic described in connection with the embodiment is included in at least one embodiment of the disclosed subject matter. Thus, appearances of the phrases “a select embodiment” “in one embodiment” or “in an embodiment” in various places throughout this specification are not necessarily referring to the same embodiment.

Furthermore, the described features, structures, or characteristics may be combined in any suitable manner in one or more embodiments. In the following description, numerous specific details are provided, to provide a thorough understanding of embodiments of the disclosed subject matter. One skilled in the relevant art will recognize, however, that the disclosed subject matter can be practiced without one or more of the specific details, or with other methods, components, materials, etc. In other instances, well-known structures, materials, or operations are not shown or described in detail to avoid obscuring aspects of the disclosed subject matter.

All numeric values are herein assumed to be modified by the term “about,” whether or not explicitly indicated. The term “about” generally refers to a range of numbers that one of skill in the art would consider equivalent to the recited value (i.e., having the same or substantially the same function or result). In many instances, the terms “about” may include numbers that are rounded to the nearest significant figure. The recitation of numerical ranges by endpoints includes all numbers within that range (e.g., 1 to 5 includes 1, 1.5, 2, 2.75, 3, 3.80, 4, and 5).

As used in this specification and the appended claims, the singular forms “a,” “an,” and “the” include or otherwise refer to singular as well as plural referents, unless the content clearly dictates otherwise. As used in this specification and the appended claims, the term “or” is generally employed to include “and/or,” unless the content clearly dictates otherwise.

The following detailed description should be read with reference to the drawings, in which similar elements in different drawings are identified with the same reference numbers. The drawings, which are not necessarily to scale, depict illustrative embodiments and are not intended to limit the scope of the disclosure.

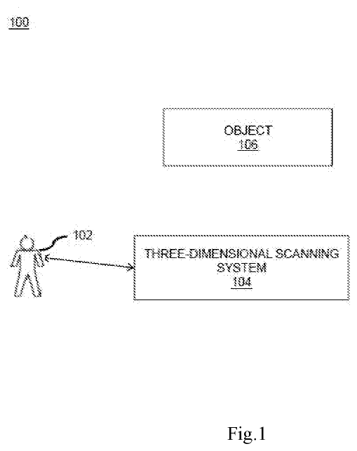

FIG. 1 illustrates an exemplary environment 100 where various embodiments of the present disclosure may function. As shown, the environment 100 primarily includes a user 102, a 3D scanning system 104 (also referred as laser-guided scanning system 104) for 3D scanning of an object 106. In some embodiments, the user 102 may use the 3D scanning system 104 to capture one or more image shots for three-dimensional scanning of the object 106 based on a feedback and at least one user input. The 3D scanning system 104 may include a visual feedback module and a depth sensor comprising an RGBD camera for scanning. Further, the 3D scanning system 104 may provide a visual feedback about the 3D scanning to the user 102 in real-time to enable the user 102 to monitor an extent and quality of scanning. The depth sensor or the RGBD camera may be configured to create a depth map or point cloud of an object. The depth map may be an image or image channel that contains information relating to the distance of the surfaces of scene objects from a viewpoint. The point cloud may be a set of data points in some coordinate system. Usually, in a three-dimensional coordinate system, these points may be defined by X, Y, and Z coordinates, and may intend to represent an external surface of the object. In some embodiments, the depth sensor may be least one of a RGB-D camera, a Time-of-Flight (ToF) camera, a ranging camera, and a Flash LIDAR.

In some embodiments, the 3D scanning system 104 is configured to create a point cloud of the object 106. The 3D scanning system 104 is configured to merge the point cloud and at least one image shot for real-time rendering of the object 106. Further, the 3D scanning system 104 is configured to provide a feedback on a display module or screen regarding rendering of the object 106 in real-time. The feedback may be a visual feedback provided to the user 102 on the screen. Therefore, the user 102 can view and review the scanning process on the screen. For example, if the user 102 thinks the scanning quality is not good then the user 102 may rescan the object by repeating the whole process of scanning. In other embodiments, the user 102 may adjust one or more rendering attributes such as, but not limited to, size, shining content, color, shading, and so forth of the object.

Further, the feedback may include a new coordinate for taking a next shot of one or more shots of the object 106. The user 102 may move the 3D scanning system 104 to the exact position for taking the shot. In some embodiments, the feedback may include an audio feedback, a video feedback, and combination of these. The audio feedback may include sounds, audio messages, and so forth. The video feedback may include video messages, displayed text, and so forth. In some embodiments, the user 102 accesses the 3D scanning system 104 directly.

Further, the object 106 may be a symmetrical object and an unsymmetrical object. Examples of the object 106 may include a person, a chair, a building, a house, an electric appliance, and so forth. Though only one object 106 is shown, but a person ordinarily skilled in the art will appreciate that the environment 100 may include more than one object 106.

In some embodiments, the 3D scanning system 104 is configured to 3D scan the object 106. Hereinafter, the 3D scanning system 104 may be referred as a feedback-based scanning system 104 without change in its meaning. In some embodiments, the 3D scanning system 104 is configured to capture one or more images of the object 106 for completing a 360-degree view of the object 106. Further in some embodiments, the 3D scanning system 104 may be configured to generate 3D scanned models and images of the object 106. In some embodiments, the 3D scanning system 104 may be a device or a combination of multiple devices, configured to analyse a real-world object or an environment and may collect/capture data about its shape and appearance, for example, colour, height, length width, and so forth. The 3D scanning system 104 may use the collected data to construct a digital three-dimensional model. The 3D scanning system 104 may indicate/signal via a feedback to the user 102 for taking one or more shots or images of the object 106. For example, the 3D scanning system 104 may create a sound for indicating an exact position for taking a shot to the user 102. In some embodiments, for taking each of the shots, the 3D scanning system 104 comprises a laser light configured to point a green light to an exact location to the user 102 for taking the shot of the object 106. The 3D scanning system 104 may provide one or more feedback to the user 102 for taking the one or more shots one by one. For instance the user 102 may provide a feedback F1 for taking a shot N1, a feedback F2 for taking a shot N2, and so on.

Further, the 3D scanning system 104 may define a laser center coordinate for the object 106 from a first shot. Further, the 3D scanning system 104 may define the exact position for taking the one or more shots without disturbing the laser center coordinate for the object 106. Further, the 3D scanning system 104 is configured to define a new position coordinate of the user 102 based on the laser center coordinate and a relative width of the shot. The 3D scanning system 104 may be configured to capture the one or more shots of the object 106 one by one based on the one or more feedbacks. In some embodiments, the 3D scanning system 104 may take the one or more shots of the object 106 one by one based on the laser center coordinate and a relative width of a first shot of the shots. The one or more shots may refer to shots taken one by one after the first shot. Further, the 3D scanning system 104 may capture multiple shots of the object 106 for completing a 360-degree view of the object 106. Furthermore, the 3D scanning system 104 may stitch and process the multiple shots to generate at least one 3D model including a scanned image of the object 106.

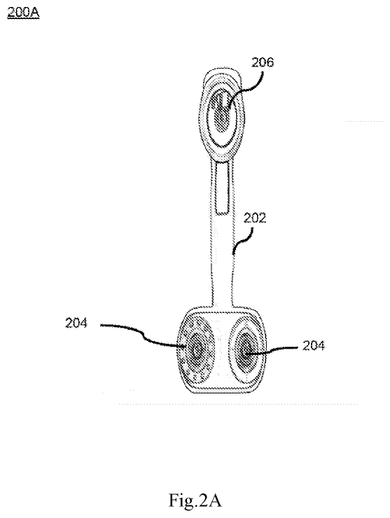

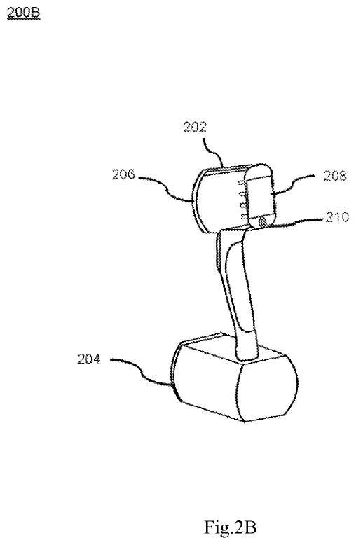

FIG. 2 illustrates a front view 200 of an exemplary 3D scanning system 202 according to an embodiment of the present disclosure. As shown, the 3D scanning system 202 includes a depth sensor 204 and a number of cameras 206. The depth sensor 204 may be inbuilt in a camera of the 3D scanning system 202. The depth sensor 204 is configured to create a point cloud of an object, such as the object 106 of FIG. 1. The point cloud may be a set of data points in a coordinate system. In a three-dimensional coordinate system, these points may be defined by X, Y, and Z coordinates, and may intend to represent an external surface of the object 106. The depth sensor 204 may be at least one of a RGB-D camera, a Time-of-Flight (ToF) camera, a ranging camera, and a Flash LIDAR.

The cameras 206 may be configured to take one or more image shots of the object 106. The user 102 may move the system 202 from a position to an exact as specified by the laser light or the feedback for taking the image shots. Further, the one or more cameras 206 may be configured to capture one or more shots of the object 106 one by one based on the feedback. In some embodiments, the 3D scanning system 202 may also include a button (not shown) for taking shots and images of the object 106. In some embodiments, the camera 206 may take a first shot and the one or more shots of the object 106 based on a laser center coordinate and a relative width of the first shot such that the laser center coordinate remains undisturbed while taking the plurality of shots of the object.

Further, the 3D scanning system 202 includes a laser light configured to indicate an exact position for taking a shot by pointing a specific colour such as a green colour, light to the exact position.

FIG. 2B illustrates a back view of the 3D scanning system 202. As shown, the 3D scanning system 202 also includes a display module 208 for displaying the visual feedbacks or rendering of the object 106 to the user 102 in real-time. The display module 208 may comprises a screen may also be configured to provide or display a feedback including a video feedback to the user 102 about an exact position for taking a shot of an object such as the object 106 as discussed with reference to FIG. 1. For example, a video message or a text message including exact position information or other scanning information may be displayed on the display module or screen 208. The user 102 may move the 3D scanning system 202 to the exact position for taking the image shot. In some embodiments, the 3D scanning system 202 may also include at least one inbuilt speaker for providing audio feedbacks. The feedback may include a new coordinate for taking a next shot of one or more shots of the object 106. The audio feedback may include sounds, audio messages, and so forth. The video feedback may include video messages, displayed text, and so forth. The visual feedback may also be provided on the display module 208, i.e. the screen 208, for showing real-time object rendering or scanning process to the user 102. The user 102 if feels the rendering of the object is not of good quality then the user 102 may decide to take one or more measures. For example, the user 102 may re-scan the object 106 or may adjust one or more rendering attributes.

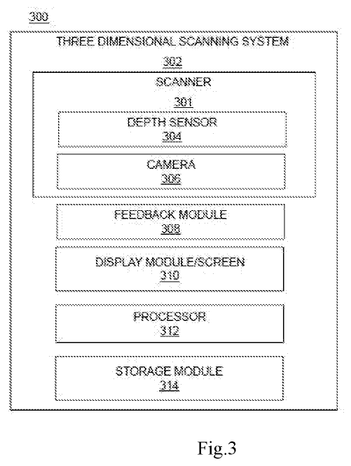

FIG. 3 is a block diagram 300 illustrating system elements of an exemplary 3D scanning system 302, in accordance with an embodiment of the present disclosure. As shown, the 3D scanning system 302 primarily includes a scanner 301 comprising a depth sensor 304 and one or more cameras 306. The 3D scanning system 302 further includes a feedback module 308, a display screen or module 310, a processor 312, and a storage module 314. As discussed with reference to FIG. 1, the user 102 may use the 3D scanning system 302 for 3D scanning the object 106. The depth sensor 304 may be configured to create point cloud of an object, such as the object 106 of FIG. 1. The point cloud may be a set of data points in a specific coordinate system. In a three-dimensional coordinate system, these points may be defined by X, Y, and Z coordinates, and may intend to represent an external surface of an object.

The cameras 306 may be configured to take one or more image shots of the object 106. The user 102 may move the system 302 from a position to an exact as specified by the laser light or the feedback for taking the image shots. Further, the one or more cameras 306 may be configured to capture one or more shots of the object 106 one by one based on the feedback. In some embodiments, the 3D scanning system 302 may also include a button (not shown) for taking shots and images of the object 106. In some embodiments, the cameras 306 may take a first shot and the one or more shots of the object 106 based on a laser center coordinate and a relative width of the first shot such that the laser center coordinate remains undisturbed while taking the image shots of the object 106. In some embodiments, the depth sensor 304 comprises at least one of a RGB-D camera, a Time-of-Flight (ToF) camera, a ranging camera, and a Flash LIDAR.

In some embodiments, the scanning system 302 may include a laser light (not shown) configured to indicate the exact position by using a green color for taking the at least one shot.

The one or more cameras 306 may be configured to capture one or more shots/images of the object 106 for completing a 360-degree view of the object 106. In some embodiments, the one or more cameras 306 may be configured to capture the one or more shots based the one or more feedback from the feedback module 308. In some embodiments, the 3D scanning system 302 may have only one camera 306. The one or more cameras 306 may further be configured to take the plurality of shots of the object 106 based on a laser center coordinate and a relative width of a first shot of the plurality of shots. In some embodiments, the laser center coordinate may be kept un-disturbed while taking the plurality of shots of the object 106 after the first shot. For each of the plurality of shots, the feedback module 308 provides a feedback regarding an exact position for taking each of the shot. In some embodiments, the feedback module 308 includes at least one inbuilt speaker (not shown) for providing audio feedbacks or creating sounds.

In some embodiments, the feedback module 308 is configured to provide one or more feedbacks about rendering of the object 106 and an exact position for taking one or more shots. The feedback may include a new coordinate for taking a next shot of one or more shots of the object 106. The user 102 may move the feedback-based lased guided scanning system 302 to the exact position for taking the shot. The feedback may include an audio feedback, a video feedback, and combination of these. The audio feedback may include sounds, audio messages, and so forth. The video feedback may include video messages, displayed text, and so forth. In some embodiments, the video feedback may be displayed on the screen 310. For example, scanning information comprising position coordinate for taking the one or more shots may be displayed on the display module/screen 310. The feedback module 308 configured to provide a feedback on a display screen in real-time so that a user can review at least one of a rendering and scanning of the object in real-time.

The display module/screen 310 may be configured to display the visual feedbacks or render of the object 106 to the user 102 in real-time. The display module/screen 310 may comprises a screen 310 may also be configured to provide or display a feedback including a video feedback to the user 102 about an exact position for taking a shot of an object such as the object 106 as discussed with reference to FIG. 1. For example, a video message or a text message including exact position information or other scanning information may be displayed on the display screen 308. The user 102 may move the 3D scanning system 302 to the exact position for taking the image shot. In some embodiments, the 3D scanning system 302 may also include at least one inbuilt speaker for providing audio feedbacks. The feedback may include a new coordinate for taking a next shot of one or more shots of the object 106. The audio feedback may include sounds, audio messages, and so forth. The video feedback may include video messages, displayed text, and so forth. The visual feedback may also be provided on the display module 208, i.e. the screen 310, for showing object's rendering or scanning process to the user 102 in real-time. The user 102 if feels the rendering of the object is not of good quality then the user 102 may decide to take one or more measures. For example, the user 102 may re-scan the object 106 or may adjust one or more rendering attributes.

In some embodiments, the processor 312 is configured to render the object 106 in real-time by merging and processing the point cloud with the at least one image shot for generating a 3D scanned image. Further, when the user 102 wants to make any changes in the rendering of the object 106 then the user 102 may provide an input during the rendering and processing of the object 106 for enhancing a quality of the scanned image in real-time, wherein the feedback is sent to the feedback module 308 in real-time for presenting to the user 102.

The processor 312 may also be configured to render the object 106. Furthermore, the processor 312 may be configured to merge and process the point cloud with the image shot for generating a 3D scanned image of the object 106. Further, the processor 312 may be configured to define the laser center coordinate for the object 106 from the first shot of the plurality of shots. In some embodiments, an exact position for taking an image shot may be defined without disturbing the laser center coordinate for the object 106. The exact position may comprise one or more position coordinates. The processor 312 may also be configured to stitch and process the plurality of shots in real-time to generate at least one 3D model including a scanned image of the object 106. The processor 312 may also be configured to define a new position coordinate of the user 102 based on the laser center coordinate and the relative width of the shot.

In some embodiments, the feedback module 308 may be configured to receive a feedback from a remote processor (not shown). In some embodiments, the processor 312 may not be a part of the 3D scanning system. In such scenarios, the processor 312 may be present in a cloud network. In such embodiments, the point cloud and the image shot may be sent to the processor 312 in the cloud for processing.

The storage module 314 may be configured to store the images, rendered images, instructions for scanning and rendering of the object 106, and 3D models. In some embodiments, the storage module 314 may be a memory. In some embodiments, the 3D scanning system 302 may also include a button (not shown). The user 102 may capture the shots or images by pressing or touching the button.

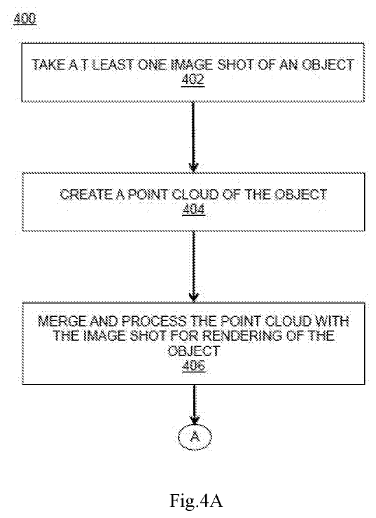

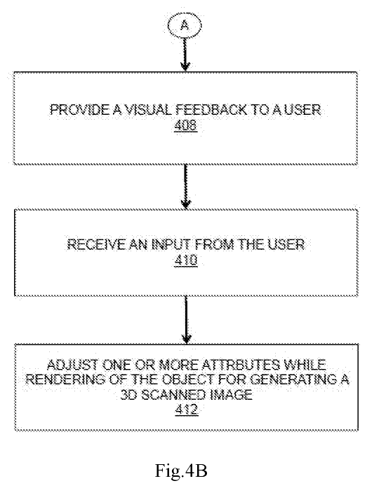

FIGS. 4A-4B illustrates a flowchart of a method 400 for a 3 dimensional (3D) scanning of an object based on a visual feedback, in accordance with an embodiment of the present disclosure.

At step 402, the user 102 takes at least one image shot of an object using a camera of a 3D scanning system as disclosed above. Then at step 404, a point cloud of the object is created. At step 406, the point cloud and the at least one image shot are merged for rendering of the object by the processor of the 3D scanning system. At step 408, a visual feedback is provided to the user. Then at step 410, an input is received from the user. Thereafter at step 412, one or more attributes of rendering of the object are adjusted for enhancing a quality of the object rendering or scanning process and generating a 3D scanned image.

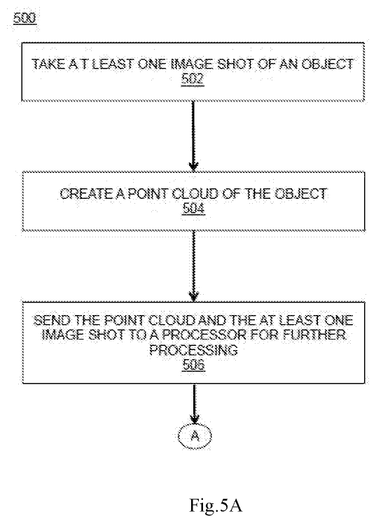

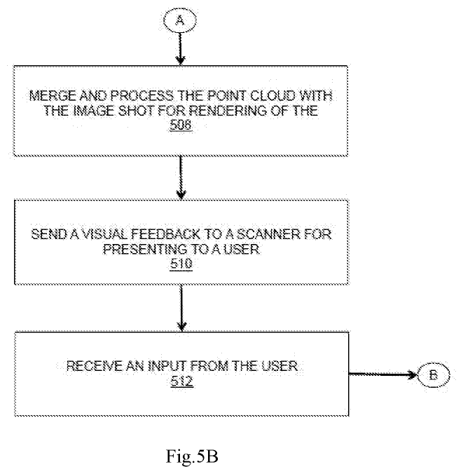

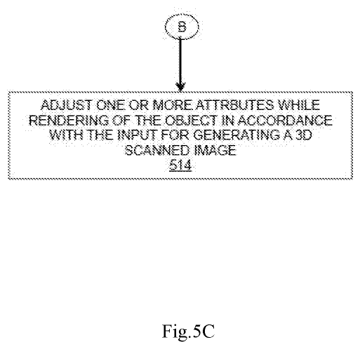

FIGS. 5A-5C illustrates a flowchart of a method 500 for a three-dimensional (3D) scanning of an object based on a real-time video feedback, in accordance with another embodiment of the present disclosure.

At step 502, the user 102 takes at least one image shot of an object. Then at step 504, a depth sensor of a 3D scanning system creates a point cloud of the object. At step 506, the point cloud and the at least one image shot are sent to a processor located remotely from the scanning system for processing.

At step 508, the processor merges the point cloud and the at least one image shot for rendering of the object. Then at step 510, a visual feedback is sent to the scanner for displaying to the user in real-time. At step 512, the processor may receive an input from the user in real-time. Then at step 514, one or more attributes of rendering are adjusted based on the input while rendering of the object.

Embodiments of the disclosure are also described above with reference to flowchart illustrations and/or block diagrams of methods and systems. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the acts specified in the flowchart and/or block diagram block or blocks. These computer program instructions may also be stored in a computer-readable memory that can direct a computer or other programmable data processing apparatus to operate in a particular manner, such that the instructions stored in the computer-readable memory produce an article of manufacture including instruction means which implement the acts specified in the flowchart and/or block diagram block or blocks. The computer program instructions may also be loaded onto a computer or other programmable data processing apparatus to cause a series of operations to be performed on the computer or other programmable apparatus to produce a computer implemented process such that the instructions which execute on the computer or other programmable apparatus provide steps for implementing the acts specified in the flowchart and/or block diagram block or blocks.

In addition, methods and functions described herein are not limited to any particular sequence, and the acts or blocks relating thereto can be performed in other sequences that are appropriate. For example, described acts or blocks may be performed in an order other than that specifically disclosed, or multiple acts or blocks may be combined in a single act or block.

While the invention has been described in connection with what is presently considered to be the most practical and various embodiments, it is to be understood that the invention is not to be limited to the disclosed embodiments, but on the contrary, is intended to cover various modifications and equivalent arrangements.

What is claimed is:

1. A three-dimensional (3D) scanning system for scanning of an object, comprising:
one or more cameras configured to take at least one image shot of the object for scanning;
a depth sensor configured to create a point cloud of the object;
a feedback module configured to provide a feedback on a display screen in real-time so that a user can review at least one of a rendering and scanning of the object in real-time; and
a processor configured to render the object in real-time by merging and processing the point cloud with the at least one image shot for generating a 3D scanned image, when the user wants to make any changes in the rendering of the object then the user provides an input during the rendering and processing of the object for enhancing a quality of the scanned image in real-time, wherein the feedback is sent to the feedback module in real-time for presenting to the user.

2. The three-dimensional scanning system of claim 1, wherein the depth sensor comprises at least one of a RGB-D camera, a Time-of-Flight (ToF) camera, a ranging camera, and a Flash LIDAR.

3. The three-dimensional scanning system of claim 1, wherein the input provided by the user comprises one or more attributes of rendering the object.

4. The three-dimensional scanning system of claim 1, wherein the one or more cameras takes the at least one shot of the object one by one based on the laser center co-ordinate and a relative width of a first shot.

5. The three-dimensional scanning system of claim 1 further comprising a laser light configured to indicate the exact position by using a green color for taking the at least one shot.

6. A laser guided three-dimensional (3D) scanning system for 3D scanning of an object, comprising:
a scanner comprising:
a depth sensor configured to create a point cloud of the object; and
one or more cameras configured to take at least one image shot of the object for scanning;
a feedback module configured to provide a visual feedback on a display module in real-time so that a user can review at least one of a rendering and scanning of the object in real-time; and
a processor based in a cloud network configured to:
receive the point cloud and the at least one image shot from the scanner;
send the visual feedback to the feedback module in real-time for presenting to the user;
render the object in real-time by merging and processing the point cloud with the at least one image shot to generate a 3D scanned image, when the user wants to make any changes in the rendering of the object then the user provides an input during the rendering and processing of the object for enhancing a quality of the scanned image in real-time; and
send the 3D scanned image of the object to the scanner for display to the user.

7. The laser guided three-dimensional scanning system of claim 6, wherein the processor is further configured to define a laser co-ordinate and an exact position for taking the at least one image shot of the object.

8. The laser guided three-dimensional scanning system of claim 7, wherein the depth sensor comprises at least one of a RGB-D camera, a Time-of-Flight (ToF) camera, a ranging camera, and a Flash LIDAR.

9. The laser guided three-dimensional scanning system of claim 6, wherein the input provided by the user comprises one or more attributes of rendering the object.

10. The laser guided three-dimensional scanning system of claim 6 further comprising a laser light configured to indicate the exact position by using a green color for taking the at least one shot.

11. The laser guided three-dimensional scanning system of claim 6, wherein the object comprises at least one of a symmetrical object and an unsymmetrical object.

12. A method for three-dimensional (3D) scanning of an object, comprising:
taking at least one image shot of the object for scanning;
creating a point cloud of the object;
providing a feedback on a display screen in real-time so that a user can review at least one of a rendering and scanning of the object in real-time; and
rendering the object in real-time by merging and processing the point cloud with at least one image shot for generating a 3D scanned image, when the user wants to make any changes in the rendering of the object then the user provides an input during the rendering and processing of the object for enhancing a quality of the scanned image in real-time, wherein the feedback is sent to the feedback module in real-time for presenting to the user.

13.-15. (canceled)
